(19) United States
(12) Patent Application Publication
(10) Pub. No.: US 2025/0376110 A1
(43) Pub. Date: Dec. 11, 2025

(54) ASSIST SYSTEM FOR A MOTOR VEHICLE

(71) Applicant: Ford Global Technologies, LLC, Dearborn, MI (US)

(72) Inventors: Aleksander Bronislaw Spychala, Gdansk (PL); Vincent Jannick Frisch, Cologne (DE); Gerald Doerne, Cologne (DE); Michael Koherr, Euskirchen (DE); Matthias Christian Reiter, Aachen (DE); Dietmar Koesters, Leverkusen (DE)

(73) Assignee: Ford Global Technologies, LLC, Dearborn, MI (US)

(21) Appl. No.: 19/211,735

(22) Filed: May 19, 2025

(30) Foreign Application Priority Data
Jun. 10, 2024 (DE) 102024116065.9

(51) Int. Cl. B60Q 3/70

(52) U.S. Cl. CPC B60Q 3/70; B60Q 2500/00

(57) ABSTRACT

An assist system for a motor vehicle having a sensor arrangement, a lighting system for a vehicle interior compartment, which has at least one lighting element, and a control unit. The control unit is configured so as by use of the sensor arrangement to detect at least one movement parameter of the motor vehicle. In order to provide a driver of a motor vehicle with relevant driving information in an enhanced manner, the control unit is configured to actuate the lighting system in dependence upon at least one detected movement parameter of the motor vehicle in order to generate a light signal and thereby provide driving information for a driver.

### CROSS-REFERENCE TO RELATED APPLICATION

This application claims foreign priority benefits under 35 U.S.C. § 119(a)-(d) to German Application No. 102024116065.9 filed Jun. 10, 2024, which is hereby incorporated by reference in its entirety.

### FIELD OF THE DISCLOSURE

The present disclosure generally relates to vehicle driving assist, and more particularly relates to an assist system for a motor vehicle.

### BACKGROUND OF THE DISCLOSURE

In recent years, single or multi-colored light emitting diodes (LEDs) in various forms have been increasingly used in motor vehicles, especially in passenger cars. Generally, such LEDs are used for indirect illumination or in light barriers at different positions in the motor vehicle, particularly in the internal passenger compartment. It is usually possible to control the level of brightness and color of these LED segments. LEDs are also currently used in order to display functions or statuses. A color change can thus be triggered in dependence upon specific events. For example, an LED element on the door handle may light up red when the door is opened.

It would be desirable to be able to provide a driver of a motor vehicle with relevant driving information in an enhanced manner.

### SUMMARY OF THE DISCLOSURE

According to a first aspect of the present disclosure, an assist system for a motor vehicle has a sensor arrangement and a lighting system for a vehicle interior compartment. The lighting system has at least one lighting element. The disclosure further has a control unit configured so as by use of the sensor arrangement to detect at least one movement parameter of the motor vehicle. The control unit is configured to actuate the lighting system in dependence upon at least one detected movement parameter of the motor vehicle in order to generate a light signal and thereby provide driving information for a driver.

Embodiments of the first aspect of the present disclosure can include any one or a combination of the following features:
the lighting system is configured to generate a light signal in a field of vision which can be perceived by the driver when looking straight ahead and/or to generate a light signal in such a manner that the driving information is visible by peripheral vision;
the control unit is configured so as, in order to provide the driving information, to adjust at least one of a color, a level of brightness, a brightness oscillation, a position, a movement direction and a movement speed at least of one light signal;
the control unit is configured to detect a curve lying ahead and in dependence upon at least one detected movement parameter to provide driving information relating to the curve;
the provided driving information corresponds to a direction of the curve, a curve radius and/or a relationship between a driving speed and a maximum speed recommended for negotiating the curve;
the driving information corresponds to a driving speed and/or a longitudinal acceleration of the motor vehicle, and wherein a color, a movement direction and/or a movement speed of at least one light signal depends upon the driving speed and/or the longitudinal acceleration;
the at least one lighting element is arranged adjacent to at least one of a front window and a side window of the motor vehicle;
the lighting system has a horizontally running strip-shaped light field, wherein a plurality of lighting elements are arranged in succession along the light field;
the control unit is configured to actuate the lighting system in dependence upon a stability parameter of the motor vehicle;
the stability parameter of the motor vehicle is selected from a lateral acceleration, a stability index and/or a yaw rate; and
the control unit is configured to adjust a position of at least one light signal in dependence upon whether under-steering or over-steering is present.

According to a second aspect of the present disclosure, an assist system for a motor vehicle, the assist system has a sensor arrangement and a lighting system for a vehicle interior compartment. The lighting system has at least one lighting element. The disclosure further has a control unit configured so as by use of the sensor arrangement to detect at least one movement parameter of the motor vehicle. The control unit is configured to actuate the lighting system in dependence upon at least one detected movement parameter of the motor vehicle in order to generate a light signal and thereby provide driving information for a driver. In order to provide the driving information, the control unit is further configured to adjust at least one of a color, a level of brightness, a brightness oscillation, a position, a movement direction and a movement speed at least of one light signal. The control unit also detects a curve lying ahead and in dependence upon at least one detected movement parameter to provide driving information relating to the curve.

Embodiments of the second aspect of the present disclosure can include any one or a combination of the following features:
the provided driving information corresponds to a direction of the curve, a curve radius and/or a relationship between a driving speed and a maximum speed recommended for negotiating the curve;
the lighting system is configured to generate a light signal in a field of vision which can be perceived by the driver when looking straight ahead and/or to generate a light signal in such a manner that the driving information is visible by peripheral vision;
the driving information corresponds to a driving speed and/or a longitudinal acceleration of the motor vehicle, and wherein a color, a movement direction and/or a movement speed of at least one light signal depends upon the driving speed and/or the longitudinal acceleration;
the at least one lighting element is arranged adjacent to at least one of a front window and a side window of the motor vehicle;
the lighting system has a horizontally running strip-shaped light field, wherein a plurality of lighting elements are arranged in succession along the light field;
the control unit is configured to actuate the lighting system in dependence upon a stability parameter of the motor vehicle;
the stability parameter of the motor vehicle is selected from a lateral acceleration, a stability index and/or a yaw rate; and
the control unit is configured to adjust a position of at least one light signal in dependence upon whether under-steering or over-steering is present.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic plan view of a motor vehicle having an assist system in accordance with one embodiment;

FIG. 2 is a perspective view of the interior compartment of the motor vehicle shown in FIG. 1 and a straight road lying ahead in one situation;

FIG. 3 is a perspective view of the interior compartment of the motor vehicle shown in FIG. 1 and a straight road lying ahead in another situation;

FIG. 4 is a perspective view of the interior compartment of the motor vehicle shown in FIG. 1 and a curved road lying ahead in another situation;

FIG. 5 is a perspective view of the interior compartment of the motor vehicle shown in FIG. 1 and a curved road lying ahead in another situation;

FIG. 6 is a perspective view of the interior compartment of the motor vehicle shown in FIG. 1 and a curved road lying ahead in another situation;

FIG. 7 is a perspective view of the interior compartment of the motor vehicle shown in FIG. 1 and a straight road lying ahead in another situation;

FIG. 8 is a perspective view of the interior compartment of the motor vehicle shown in FIG. 1 and a straight road lying ahead in another situation; and

FIG. 9 is a perspective view of the interior compartment of the motor vehicle shown in FIG. 1 and a straight road lying ahead in a further situation.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

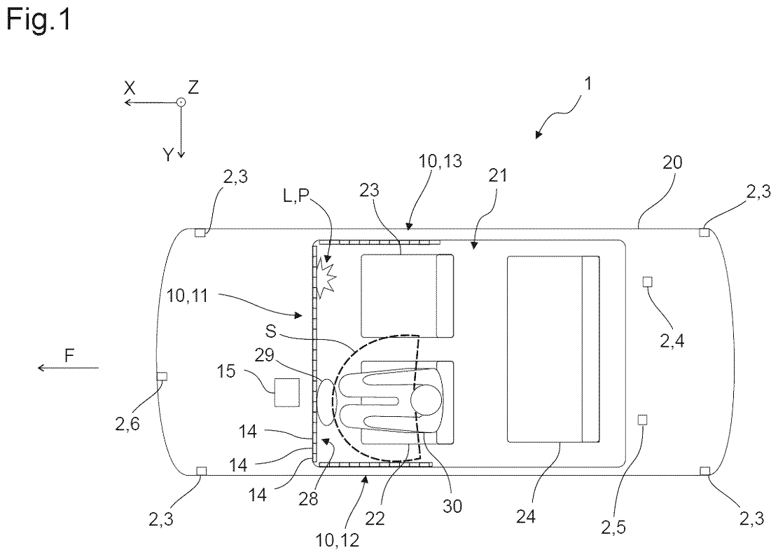

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to an assist system for a motor vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Like parts in the different figures are always provided with the same reference characters, so that these parts are also generally described only once.

FIG. 1 shows a plan view of a motor vehicle 20 configured as a passenger car, according to one example. A longitudinal axis X, a transverse axis Y, a vertical axis Z and a direction of travel F of the motor vehicle 20 are shown. The motor vehicle 20 has a vehicle interior compartment 21, in which are arranged a driver's seat 22, a passenger seat 23 and a rear bench 24. A dashboard 28 and a steering wheel 29 are arranged in front of the driver's seat 22. A plurality of lighting elements 14 of a lighting system 10 are arranged within the vehicle interior compartment 21 and configured so as to generate different light signals L. A plurality of sensors 3-6 of a sensor arrangement 2 are integrated in the motor vehicle 20. In this case, this involves by way of example inertia sensors 3, a speed sensor 4, a global positioning system (GPS) sensor 5 and a LiDAR sensor 6. In addition, it is possible via one or more sensors, not illustrated, to detect a steering angle of the front axle and/or a position of the steering wheel 29. The positions shown of the sensors 3-6 may not necessarily match the actual installation position. The sensor arrangement 2 and the lighting system 10 are connected by data lines, not illustrated, to a control unit 15 and together form parts of an assist system 1 in accordance with the disclosure. The control unit 15 is configured so as to actuate the lighting system 10 in order, by use of one or more light signals L, to display relevant driving information for a driver 30.

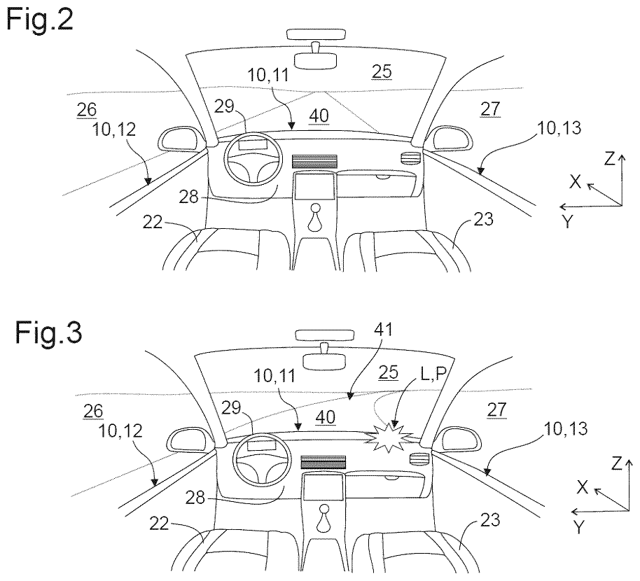

The lighting elements 14 of the lighting system 10 are arranged in three strip-shaped light fields 11-13. Each lighting element 14 can be actuated individually by the control unit 15. As can be seen in FIGS. 2 to 9, which in each case show perspective views of the vehicle interior compartment 21 and a view of a road 40 lying ahead, a front light field 11 is arranged adjacent to a front window 25, more precisely below it and above the dashboard 28. The front light field 11 runs horizontally approximately in the direction of the transverse axis Y. A left-hand light field 12 is arranged adjacent to a left-hand side window 26 and below the left-hand side window 26. The left-hand light field 12 runs horizontally approximately parallel to the longitudinal axis X. A right-hand light field 13 is arranged adjacent to a right-hand side window 27 and below the right-hand side window 27. The right-hand light field 13 runs horizontally approximately parallel to the longitudinal axis X. Each of the light fields 11-13 is arranged at a vertical distance of at least 5 cm from the respective window 25-27 and runs in the horizontal direction over more than 50 cm. For reasons of clarity, the individual lighting elements 14 are not illustrated in the light fields 11-13 in FIGS. 2 to 9. FIG. 1 shows not only the driver 30 but also the approximate course of a field of vision S of the driver 30. The field of vision S covers a total angle of approximately 200° in a horizontal direction, wherein the major part corresponds to a peripheral field of vision, within which the driver 30 cannot recognize details such as graphic characters but can recognize in particular changes and movements and, to a limited extent, also colors.

FIGS. 2 and 3 illustrate a first operating mode of the assist system 1. In FIG. 2, the motor vehicle 20 is illustrated moving on a straight road 40. The control unit 15 establishes the current position of the motor vehicle 20 via the GPS sensor 5. Based on the temporal change in the position and, where appropriate, on measurement values of the speed sensor 4, it is possible to determine a direction of travel, a driving speed and a longitudinal acceleration. The longitudinal acceleration can also be determined by use of the inertia sensors 3. By the control unit 15 comparing the position and movement direction of the motor vehicle 20 with a map stored internally in the vehicle or externally, the control unit establishes that currently and in a section lying ahead the road 40 is running in a straight line. Alternatively or additionally, the course of the road can also be determined by use of the LiDAR sensor 6. The straight course of the road generally does not require any special notice on the part of the driver 30. Therefore, the lighting system 10 does not display any further driving information.

This changes if the control unit 15 establishes that a curve 41 in the road is lying ahead. Such a situation is illustrated in FIG. 3. The curve 41 is shown in this case as a right-hand curve. Under certain conditions, for example in darkness or poor light conditions, the driver 30 may only notice the curve 41 relatively late. For this reason, the lighting system 10 displays appropriate driving information. For this purpose, a light signal L is generated on the front light field 11. A position P of the light signal L is arranged in the right-hand part of the front light field 11, according to the course of the curve 41. In this operating mode, the position P is stationary. In order to notify or excite the driver 30, the level of brightness of the light signal L can be varied periodically, for example by the light signal L flashing. A flashing frequency, a color and/or a level of brightness can be used for different additional information. For example, it is possible to display how large the curve radius is in relation to a current driving speed of the motor vehicle 20 or how the current driving speed behaves with regard to the recommended maximum speed for negotiating the curve 41. It could also be possible to display how close the curve 41 is to the motor vehicle 20.

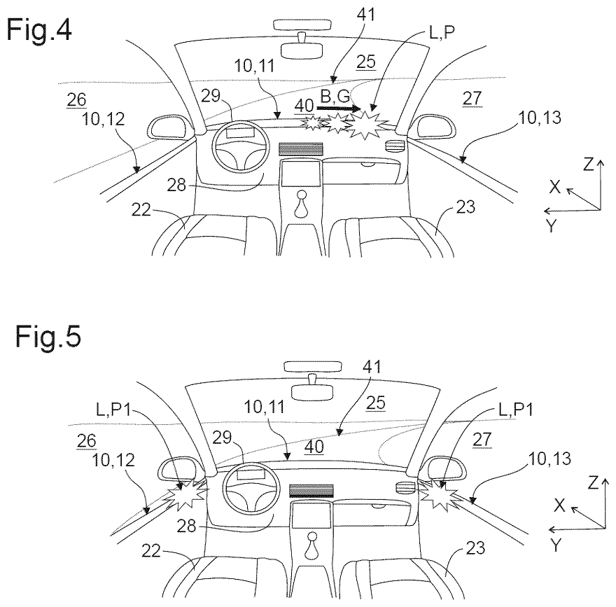

FIG. 4 shows a situation which is identical to FIG. 3 but wherein the assist system 1 is operated in a different operating mode. In this case, it is provided that the light signal L moves within the front light field 11 along a movement direction B toward the right. This intuitively shows the driver 30 the course of the curve 41. As indicated in FIG. 3, the level of brightness of the light signal L can also be changed. For example, the brightness of the light signal could become brighter during the course of its movement. The level of brightness and/or the color could also be changed in dependence upon the curve radius and driving speed or in dependence upon the distance to the curve 41. A further possibility is to change a movement speed G of the light signal L. The light signal could move, for example, quicker, if the curve radius is smaller in relation to the driving speed or if the curve 41 is already close. In FIGS. 3 and 4, in each case only the front light field 11 is used to display the curve 41. However, it would also be possible to use one of the side light fields 12, 13 since these are also peripherally visible for the driver 30.

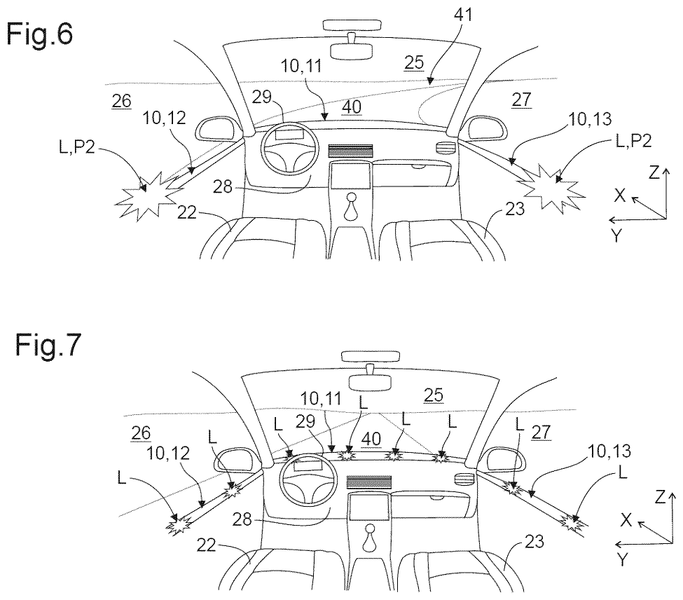

FIGS. 5 and 6 illustrate a further operating mode of the assist system 1. In this case, the control unit determines at least one stability parameter by use of the inertia sensors 3, the speed sensor 5 and the steering angle sensor, not illustrated, or the steering wheel sensor. Such a stability parameter provides information as to whether according to the steering wheel the motor vehicle 20 is currently following a predetermined direction of travel or is deviating therefrom. For example, the stability index can be determined. Where appropriate, the stability parameter can also provide information as to whether a possible deviation from the direction of travel could be anticipated. Such a deviation can consist in particular of over-steering or under-steering. FIG. 5 shows a situation in which the motor vehicle 20 starts to under-steer within the curve 41. In other words, a front axle of the motor vehicle 20 deviates with respect to the curve 41 outward from the intended direction of travel. This is displayed to the driver 30 by use of two light signals L in the side light fields 12, 13. The respective light signal L is arranged in a front position P1 which notifies the driver 30 in a intuitively understandable manner that breaking-out is occurring in the region of the front axle. FIG. 6 shows a situation in which the motor vehicle 20 over-steers, i.e. a rear axle of the motor vehicle 20 deviates with respect to the curve 41 outward from the intended direction of travel. This is displayed to the driver 30 in turn by use of two light signals L but which are arranged in rear positions P2. This represents in turn an intuitively understandable notification that breaking-out is occurring in the region of the rear axle.

FIGS. 7 to 9 illustrate a further operating mode of the assist system 1 in which the lighting system 10 is used in order to notify the driver 30 of the driving speed and longitudinal acceleration of the motor vehicle 20. FIG. 7 shows a state in which the motor vehicle moves at a constant driving speed. Light signals L are apparent in certain spatial intervals in all three light fields 11-13. The light signals L are held spatially stationary, i.e., they do not move. Optionally, a color or a level of brightness of the light signals could be used in order to display at least qualitative whether the current driving speed is high or low. In particular, it is possible to display whether the driving speed is clearly below a predetermined or recommended maximum speed, is in the region of the maximum speed or clearly higher.

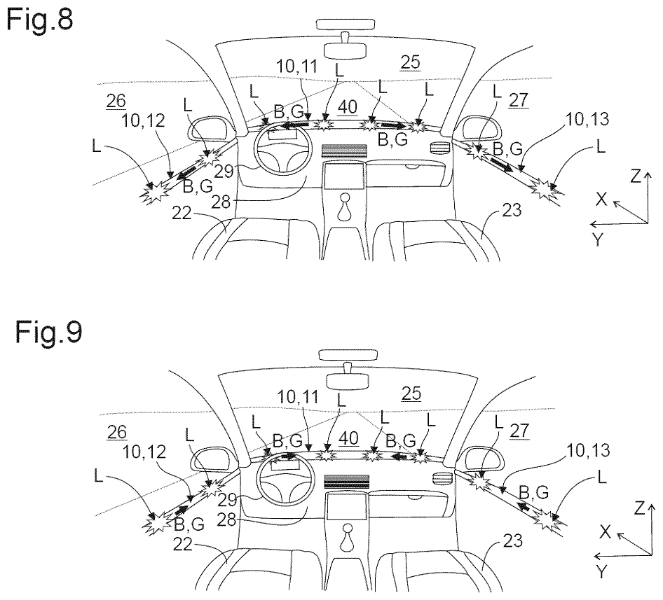

FIG. 8 shows a state in which the motor vehicle 20 accelerates by increasing the driving speed. On the other hand, at certain spatial intervals, light signals L are generated in the light fields 11-13, which do not remain stationary but rather move within the front light field 11 from inside to the outside and in the side light fields 12, 13 from the front to the rear. The respective movement directions B are shown in FIG. 8, wherein the movement speed G can be adjusted in dependence upon the amount of the longitudinal acceleration. In other words, if the motor vehicle accelerates quicker, the movement speed G is greater. Alternatively or additionally, the color and/or the level of brightness of the light signals L can also be used to display the amount of the longitudinal acceleration.

FIG. 9 shows a situation in which the driving speed reduces, such that the motor vehicle 20 decelerates. This is displayed by a reverse movement direction B of the light signals L in comparison to FIG. 8, which run forward in the area of the side light fields 12, 13 and from the outside to the inside in the front light field 11. On the other hand, the movement speed G, the color and/or the level of brightness of the light signals L can also be used to display the amount of the deceleration.

It is to be noted that the features and measures explained individually in the description below can be combined with one another in any technically expedient manner and disclose further embodiments of the disclosure. The description characterizes and specifies the disclosure in particular in addition in connection with the figures.

The disclosure provides an assist system for a motor vehicle. In this case, the term “motor vehicle” refers to a road vehicle, i.e. a motor vehicle that is suitable and approved for road traffic. In particular, it is a passenger car, a lorry, a transporter or a bus. There are no limitations with regard to the drive of the motor vehicle, it can be driven, for example, by a combustion engine which uses petrol, diesel, LPG, hydrogen or another gas as fuel. Alternatively or additionally, an electric motor can be provided, which can be supplied with energy, for example, by a battery unit and/or a fuel cell. It may be preferred that the motor vehicle has at least two axles, each with two wheels, however deviations therefrom are also conceivable. The motor vehicle can be controlled at least sometimes by a driver. However, it is also configured so as at least sometimes to drive autonomously, i.e., without being controlled by a driver. The assist system is used to support the driver.

The assist system has a sensor arrangement, a lighting system for a vehicle interior compartment, which has at least one lighting element, and a control unit. The sensor arrangement has at least one sensor which can be designed differently. The respective sensor can be configured to record one aspect of the motor vehicle itself or an aspect of an environment of the motor vehicle. In the former case, one can speak of a motor vehicle sensor, in the latter case of an environmental sensor. This can be a contact sensor, for example, a pressure or force sensor, or a non-contact sensor, for example, an optical sensor, an ultrasound sensor, a LiDAR or radar sensor. In a broader sense, the term “sensor” also refers to receivers, for example, a GPS receiver. This can be understood as a sensor for determining the position of the motor vehicle. A combination of different sensors is also conceivable. The lighting system is provided for the vehicle interior compartment and can be arranged at least in part in the vehicle interior compartment or adjacent thereto. In any case, it is configured so as to emit light which is visible within the vehicle interior compartment. In this respect, it is configured so as to illuminate the vehicle interior compartment or part thereof. It has at least one lighting element, preferably a plurality of lighting elements, in one embodiment. The respective lighting system is assigned to the vehicle interior compartment and can be arranged therein or adjacent thereto. Each lighting element is designed to generate light but can also have element parts for influencing light, in particular for light conduction, reflection, refraction, scattering, and/or focusing. It can also have an element part onto which light is projected. However, the light can also be projected onto an element which does not belong to the lighting element. In any case, it is possible that the light is actually generated at a site other than the one where the light is visible. The lighting element advantageously has at least one LED.

On the one hand, the control unit can perform control functions and on the other hand evaluation functions. It does not have to be assigned exclusively to the assist system. For example, it can be an on-board computer of the motor vehicle which is associated with other systems of the motor vehicle. The term “unit” is not to be interpreted to mean that all parts of the control unit must be physically connected and/or located in one place. It can also have a plurality of elements or sub-units that can be connected to one another, for example, via data lines. The control unit can also be referred to as a monitoring unit. It usually has hardware components, its functions can, however, be implemented at least in part in software. The control unit is connected to both the sensor arrangement and the lighting system in terms of signal transmission. The connection can be wired but a wireless connection is also possible.

The control unit is configured so as to detect at least one movement parameter of the motor vehicle by use of the sensor arrangement. The movement parameter relates to the movement of the motor vehicle, which includes both translatory and also rotary movements. It can be a movement of the entire motor vehicle or its focal point. However, in some embodiments, it can also be based on a movement of a specific motor vehicle part, such as for example the front axle or the rear axle. In particular, it is possible to detect a movement with respect to the longitudinal axis (X-axis), the transverse axis (Y-axis) and/or the vertical axis (Z-axis) or a movement of individual wheels. Alternatively or additionally, a rotation about the roll axis (longitudinal axis), the pitch axis (transverse axis), and/or the yaw axis (vertical axis) can be detected. A steering angle and/or a setting of a steering wheel can also be classified as a movement parameter in this context. It is possible to determine the presence of a movement, a speed of the movement (where appropriate an angular speed) and/or an acceleration (where appropriate an angular acceleration). This can relate to the entire vehicle but also to parts thereof, for example an axle or an individual wheel. The detection of the movement parameters can involve one or more sensors of the sensor arrangement.

In accordance with the disclosure, the control unit is configured so as to actuate the lighting system in dependence upon at least one detected movement parameter of the motor vehicle in order to generate a light signal and thereby provide driving information for a driver. The lighting system is actuated and consequently the at least one light signal generated in dependence upon at least one movement parameter which has been detected. This can mean that it is dependent upon the movement parameter as to whether a light signal is generated. It can also mean that it depends upon the movement parameter as to which characteristics the generated light signal has. In some cases, the movement parameter can be read at least qualitative from the light signal, in other words, there can be a direct correlation between the movement parameter and the light signal. In other cases, the correlation can be more complex, in particular if the light signal is generated in dependence upon a plurality of movement parameters. The generation of the light signal can also depend upon how the control unit interprets the at least one movement parameter. In addition to the at least one movement parameter, the light signal can be generated in dependence upon further parameters, for example environment parameters which describe the environment of the vehicle, or situation parameters which describe the general situation of the vehicle. A prediction can also be made for expected future environment and/or situation parameters. The light signal can be generated by at least one lighting element, or in some cases by a plurality of lighting elements. Driving information is provided to the driver by the at least one light signal. The driving information, and consequently the underlying at least one light signal, can be perceived by the driver of the motor vehicle. The driving information relates in general to the driving state of the motor vehicle and/or to a situation in which the motor vehicle is involved or is about to be involved in. In this respect, the driving information can be informative.

The driving information is conveyed by the at least one light signal which has various advantages. On the one hand, the light signal is particularly easy to perceive even in darkness, which is a situation in which the driver is less able to perceive the driving state of the motor vehicle and/or the environment and is therefore more dependent on support. Furthermore, the driver can recognize the light signal more easily and more quickly than, for example, a display on the dashboard. In particular, it is possible to design the light signal in such a manner that the driver does not have to take their eyes off the road lying ahead in order to take note of the driving information. Finally, the lighting system can perform a dual function. If a lighting element is not required for displaying driving information, it can be used to emit a light which facilitates orientation in the interior compartment or, where appropriate, highlights the interior compartment using lighting technology.

The lighting system can be advantageously configured so as to generate a light signal in a field of vision which can be perceived by the driver when looking straight ahead. In other words, the light signal can be generated in an area which can be perceived by the driver while they are looking straight ahead, which is generally parallel to the longitudinal axis of the motor vehicle. The exact field of vision depends to a certain extent upon the settings of the driver's seat and the body size of the driver, however it is possible to specify an area within the interior compartment which is visible for all realistic seat positions and irrespective of the size of the driver when looking straight ahead. If the light signal is in this area, the driver can perceive it while looking straight ahead at the road in front of them. In this respect, the driver does not need to take their eyes off the road. It is also possible for the light signal to be generated with respect to the longitudinal axis at the height of a driver's door or in front of it. In this case, it is typically also perceivable by the driver when looking straight ahead. Furthermore, it may be preferred that the lighting system is configured so as to generate a light signal in such a manner that the driving information can be recognized by peripheral vision. As is known, it is not possible to focus on objects in the peripheral field of vision and details cannot be recognized. Nevertheless, changes can be perceived in the peripheral field of vision, for example, changes in the level of brightness and movements. In addition, it is possible to differentiate between colors, at least to a limited extent. It may not be possible to recognize graphic characters, at least those of a normal size, in other words the driving information cannot be provided in a readable form. It can also be said that the driving information may be displayed without lettering. However, this does not exclude the possibility that, for example, a lighting element can be in the form of one or more graphic characters. However, in this case, the driving information may not be included in the graphic characters but rather in the lighting characteristic of the lighting element.

In particular, the peripheral visibility can be combined with the visibility when looking straight ahead. In this case, when looking straight ahead, the driver can perceive the at least one light signal and recognize the driving information contained therein without having to take their eyes off the road. It is to be noted with respect to the position of the light signal, that this may, but need not, coincide with the position of at least one light-generating element. The light-generating element can be hidden at least from the view of the driver or be outside their field of vision while it is illuminating a surface which is visible for the driver.

The control unit can be configured in particular so as, in order to provide the driving information, to adjust a color, a level of brightness, a brightness oscillation, a position, a movement direction and/or a movement speed at least of one light signal. Different colors can display, for example, whether the driving information is more informative. The same applies for different levels of brightness. A bright light signal is more suitable for the driver to perceive. In addition, the driver will intuitively associate a greater level of brightness with a higher level of urgency. A brightness oscillation, i.e., a temporally changing increase and reduction in the level of brightness, can also be used to notify or excite the driver. A brightness oscillation can correspond in particular to flashing, i.e., the light signal switching on and off at temporal intervals. In this case, it is possible, in turn, to vary a flashing frequency, a pulse width (i.e., the length of time the light is switched on at a constant frequency), or other parameters. A higher flashing frequency can in turn display a higher level of urgency which is to be intuitively understandable by the driver. A light signal can also move, in particular as a result of each one of a plurality of lighting elements being activated sequentially. The movement direction can also be used to provide information, such as the movement speed.

The control unit is advantageously configured so as to detect a curve lying ahead and, in dependence upon at least one detected movement parameter, to provide driving information relating to the curve. The curve lying ahead can be detected in different ways, for example by use of one or more sensors. Such a sensor can be a camera which records visible light or infra-red light. It is possible to detect a curve by use of image recognition with the aid of the recorded images. Active sensors such as radar or LiDAR could also be used. It would also be possible to link information regarding the position and movement direction of the motor vehicle, which can be determined for example via a GPS receiver, with data regarding the drive path lying ahead. The data can be called up from a database which can be stored in the motor vehicle or on one accessed via a wireless connection. It is understood that a driving speed of the motor vehicle can be particularly relevant as a movement parameter, since this is decisive for whether the curve can be negotiated. If the driving speed is very low, the curve may not need to be displayed at all. At a medium driving speed, for example, the presence of the curve can be displayed, while at a high driving speed, additional driving information regarding the driving speed (which may be too high) can be displayed. Also, the point in time at which the driving information is displayed can depend upon the driving speed. At a high driving speed, the driving information can be displayed earlier than at a low driving speed.

In particular, driving information which can be provided can correspond to a direction of the curve, a curve radius and/or a relationship between a driving speed and a maximum speed recommended for negotiating the curve. The direction of the curve can be displayed by the position of a light signal, for example on the left or right within the interior compartment. Additionally or alternatively, it can be displayed by the movement direction of a light signal. The curve radius can be displayed for example by a color of the light signal, for example a first color for a large curve radius, a second color for a medium curve radius and a third color for a small curve radius. A level of brightness or a brightness oscillation, for example a flashing speed of the light signal, could also refer to the curve radius. A further possibility would be to adjust the movement speed of the light signal in dependence upon the curve radius, for example a high movement speed in the case of a small curve radius. The information regarding the curve radius can be set in correlation with the current driving speed of the motor vehicle so that a curve with a given curve radius is displayed differently at a low driving speed than at a high driving speed. It is possible by use of at least one light signal to also display whether the driving speed is below the recommended maximum speed, within the region of the recommended maximum speed or higher than it. On the other hand, this can be displayed by different colors, levels of brightness and/or brightness oscillations.

It may be preferred that an item of driving information can correspond to a driving speed and/or a longitudinal acceleration of the motor vehicle, wherein preferably a color, a movement direction and/or a movement speed at least of one light signal can depend upon the driving speed and/or the longitudinal acceleration. In other words, the at least one light signal provides the driver with information regarding the driving speed and/or the longitudinal acceleration. The longitudinal acceleration is the acceleration of the motor vehicle in the direction of the longitudinal axis, in other words the temporal change in the driving speed. In this context, it is possible, for example, for a color of the light signal to change in dependence upon the driving speed. For example, a first color can signify that the driving speed is significantly below a maximum speed limit. A second color can signify that the driving speed is within the region of the maximum speed, while a third color can signify that the maximum speed has been exceeded, in particular considerably. Alternatively or additionally, a light signal can move, wherein the movement speed of the light signal is qualitatively related to the driving speed. Alternatively, a movement speed or a movement direction of a light signal could relate to the longitudinal acceleration. If the motor vehicle is driving at a constant speed, the light signal can be at a standstill, corresponding to a longitudinal acceleration of zero. If the motor vehicle accelerates, the light signal can be moved in a first direction, for example in the direction of the motor vehicle check. If the motor vehicle is driving slower, the light signal can move in the opposite direction. In both cases, the amount of the movement speed of the light signal relates to the amount of longitudinal acceleration. Alternatively or additionally, a brightness oscillation, for example a flashing frequency of a light signal, can also be used in order to display information with respect to the driving speed and/or longitudinal acceleration.

It may be preferred that at least one lighting element is arranged adjacent to a front window and/or to a side window of the motor vehicle. “Adjacent” preferably means that the distance of the lighting element to the respective window is a maximum 10 cm or maximum 5 cm. The lighting element can be arranged above or below the window, however, an arrangement horizontally next to the window would also be conceivable, for example on an A or B column. As a result of the arrangement adjacent to the mentioned windows, a light signal generated by the lighting element can generally be easily perceived by the driver.

Advantageously, the lighting system can have a horizontally running strip-shaped light field, wherein a plurality of lighting elements are preferably arranged in succession along the light field. The light field can also be referred to as a light band or light strip. It runs horizontally but does not need to run parallel to the horizontal plane which is defined by the longitudinal axis and the transverse axis of the motor vehicle. The light field is strip-shaped in that its horizontal extent is a multiple of its height, for example, at least five times or at least ten times. The light field can run in particular below the front window and/or below a side window. Alternatively, it can also run above the front window and/or above a side window. In the region of the front window, the light field runs along the transverse axis, in the region of a side window along the longitudinal axis. Its extent in the horizontal direction is preferably at least 20 cm, further preferably at least 50 cm. Accordingly, it extends so far in this direction that it occupies a large area in the field of vision of the driver. As a result, particularly movements of a light signal in the light field can be easily recognized in the peripheral vision. A movement of a light signal can be generated by virtue of the fact that successive lighting elements can be activated one after the other within the light field. It is also possible to generate a movement of a focal point, in other words a brightest point, by successively increasing and decreasing the level of brightness of individual lighting elements within the light field. The light signal can be moved, for example, below or above the front window to the left or to the right or below or above a side window to the rear or to the front (with respect to the longitudinal axis). In the case of multiple lighting elements, these do not have to entirely cover the light field; there can also be gaps between the lighting elements.

The control unit can be configured so as to actuate the lighting system in dependence upon a stability parameter of the motor vehicle. The stability parameter is a movement parameter which specifies or influences how stabile the motor vehicle is or is likely to be when following an intended line of travel. This can be relevant in particular when negotiating a curve. If the stability parameter suggests an at least potentially unstable driving behavior, this can be displayed via at least one light signal. The stability parameter is preferably selected from a lateral acceleration, a yaw rate and/or a stability index. In this case, a lateral acceleration is generally an acceleration in the direction of the transverse axis. The lateral acceleration can be determined for the entire motor vehicle, for example for its focal point, or lateral accelerations can be determined individually for different parts or areas. In addition, the lateral acceleration can be compared with a maximum value resulting from vehicle-specific characteristics such as tire material, tread, and tire pressure, as well as road surface characteristics such as road surface material, wetness, or icing. Alternatively or additionally, the yaw rate of the motor vehicle can also use the angular speed around the vertical axis as a stability parameter. The yaw rate can be determined by one or more inertia sensors. However, if it is used as a stability parameter, in addition at least a further variable is to be taken into consideration, in particular the steering angle selected by the driver and the motor vehicle speed. In the case of a steering angle of 0°, each yaw rate that is different from zero suggests an instability, whereas when negotiating a curve, a specific yaw rate is to be expected. This can be taken into consideration, for example, if the so-called stability index is selected as a stability parameter. This can be defined as:

$$SI = \{ \begin{matrix}1 & for \vert {ω}_{z} - {\dot{φ}}_{z - erw} \vert < {ω}_{0} \\ 0 & otherwise\end{matrix}$$

wherein SI is the stability index, ω_{z} the yaw rate, \dot{φ}_{z,erw} the yaw rate that is to be expected due to the steering angle and the speed, and ω₀ a threshold value which can be selected differently. In the case of a stability index of 0, the driver can be notified by a light signal.

In the event of instability, in particular under-steering or over-steering can be present. It can be crucial for the driver to be able to quickly recognize what type of instability is involved. It is advantageous if the driving information allows a conclusion to be drawn in this regard. In particular, the control unit can be configured so as to adjust the position of at least one light signal in dependence upon whether under-steering or over-steering is present. In other words, in the case of under-steering, the light signal is generated in a different position than in the case of over-steering. Since over-steering corresponds to the rear axle breaking out of the intended line of travel, while under-steering corresponds to the front axle breaking out, it may be preferred that the light signal is generated in a rear position in the case of over-steering and in the case of under-steering in a front position, which is located in front of the rear position relative to the longitudinal axis. This allows the driver to intuitively recognize which axle is breaking out of the curve. At least the rear position can be arranged adjacent to a side window, while the front position can also be arranged adjacent to the side window or adjacent to the front window. Both positions can be arranged on a strip-shaped light field as mentioned above.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. An assist system for a motor vehicle, the assist system comprising:
a sensor arrangement;
a lighting system for a vehicle interior compartment, wherein the lighting system has at least one lighting element; and
a control unit configured so as by use of the sensor arrangement to detect at least one movement parameter of the motor vehicle, wherein the control unit is configured to actuate the lighting system in dependence upon at least one detected movement parameter of the motor vehicle in order to generate a light signal and thereby provide driving information for a driver.

2. The assist system of claim 1, wherein the lighting system is configured to generate a light signal in a field of vision which can be perceived by the driver when looking straight ahead and/or to generate a light signal in such a manner that the driving information is visible by peripheral vision.

3. The assist system of claim 1, wherein the control unit is configured so as, in order to provide the driving information, to adjust at least one of a color, a level of brightness, a brightness oscillation, a position, a movement direction and a movement speed at least of one light signal.

4. The assist system of claim 1, wherein the control unit is configured to detect a curve lying ahead and in dependence upon at least one detected movement parameter to provide driving information relating to the curve.

5. The assist system of claim 4, wherein the provided driving information corresponds to a direction of the curve, a curve radius and/or a relationship between a driving speed and a maximum speed recommended for negotiating the curve.

6. The assist system of claim 1, wherein the driving information corresponds to a driving speed and/or a longitudinal acceleration of the motor vehicle, and wherein a color, a movement direction and/or a movement speed of at least one light signal depends upon the driving speed and/or the longitudinal acceleration.

7. The assist system of claim 1, wherein the at least one lighting element is arranged adjacent to at least one of a front window and a side window of the motor vehicle.

8. The assist system of claim 7, wherein the lighting system has a horizontally running strip-shaped light field, wherein a plurality of lighting elements are arranged in succession along the light field.

9. The assist system of claim 1, wherein the control unit is configured to actuate the lighting system in dependence upon a stability parameter of the motor vehicle.

10. The assist system of claim 9, wherein the stability parameter of the motor vehicle is selected from a lateral acceleration, a stability index and/or a yaw rate.

11. The assist system of claim 9, wherein the control unit is configured to adjust a position of at least one light signal in dependence upon whether under-steering or over-steering is present.

12. An assist system for a motor vehicle, the assist system comprising:
a sensor arrangement;
a lighting system for a vehicle interior compartment, wherein the lighting system has at least one lighting element; and
a control unit configured so as by use of the sensor arrangement to detect at least one movement parameter of the motor vehicle, wherein the control unit is configured to actuate the lighting system in dependence upon at least one detected movement parameter of the motor vehicle in order to generate a light signal and thereby provide driving information for a driver, wherein the control unit is configured so as, in order to provide the driving information, to adjust at least one of a color, a level of brightness, a brightness oscillation, a position, a movement direction and a movement speed at least of one light signal, and wherein the control unit is configured to detect a curve lying ahead and in dependence upon at least one detected movement parameter to provide driving information relating to the curve.

13. The assist system of claim 12, wherein the provided driving information corresponds to a direction of the curve, a curve radius and/or a relationship between a driving speed and a maximum speed recommended for negotiating the curve.

14. The assist system of claim 12, wherein the lighting system is configured to generate a light signal in a field of vision which can be perceived by the driver when looking straight ahead and/or to generate a light signal in such a manner that the driving information is visible by peripheral vision.

15. The assist system of claim 12, wherein the driving information corresponds to a driving speed and/or a longitudinal acceleration of the motor vehicle, and wherein a color, a movement direction and/or a movement speed of at least one light signal depends upon the driving speed and/or the longitudinal acceleration.

16. The assist system of claim 12, wherein the at least one lighting element is arranged adjacent to at least one of a front window and a side window of the motor vehicle.

17. The assist system of claim 16, wherein the lighting system has a horizontally running strip-shaped light field, wherein a plurality of lighting elements are arranged in succession along the light field.

18. The assist system of claim 12, wherein the control unit is configured to actuate the lighting system in dependence upon a stability parameter of the motor vehicle.

19. The assist system of claim 18, wherein the stability parameter of the motor vehicle is selected from a lateral acceleration, a stability index and/or a yaw rate.

20. The assist system of claim 18, wherein the control unit is configured to adjust a position of at least one light signal in dependence upon whether under-steering or over-steering is present.
